(19) United States
(12) Patent Application Publication
(10) Pub. No.: US 2014/0225389 A1
(43) Pub. Date: Aug. 14, 2014

(54) Industrial Docking Bumper

(71) Applicant: Stephen Epling, Sandston, VA (US)

(72) Inventor: Stephen Epling, Sandston, VA (US)

(21) Appl. No.: 14/180,009

(22) Filed: Feb. 13, 2014

Related U.S. Application Data
(60) Provisional application No. 61/764,045, filed on Feb. 13, 2013.

(51) Int. Cl. B65G 69/00; B60R 19/03

(52) U.S. Cl. CPC B65G 69/001; B60R 19/03
USPC 293/120; 267/140

(57) ABSTRACT

A bumper configured with multiple layers that is designed to provide durable protection to the loading dock and trailer during the docking, loading, and unloading process. The first layer absorbs impact during the docking process of the trailer to the loading dock. The second layer, placed over the first layer, provides durable protection via a UHMW Polyethylene material, specifically designed to withstand abrasion from impacts, as well as sunlight and weather abrasion for a long duration of time.

This application is a non-provisional application of provisional patent application No. 61/764,045 filed on Feb. 13, 2013, and priority is claimed thereto.

### FIELD OF THE PRESENT INVENTION

The present invention relates to bumpers, and more specifically, bumpers conventionally designed for the rear of trucks and trailers configured to dock with stationary loading bays for payload transfer.

### BACKGROUND OF THE PRESENT INVENTION

In the industrialized world, it is common for goods to be transported via ground transportation across the country. Powerful semi-trucks haul large trailers containing goods from shipping docks to manufacturers, suppliers, and retailers. Unfortunately, when these trailers dock with loading docks, often the drivers hit the loading dock in order to ensure a close seal with minimal or no gap between the truck and the loading dock, This causes the rear bumper of the truck to bind against bumpers located on the loading docks.

Bumpers have been crafted to help minimize damage to the rear of the truck and damage to the loading dock itself during the docking, loading and unloading processes. Conventionally, these bumpers are composed of rubber polymers, which must be replaced every six months due to excessive wear caused by the friction experienced by the bumpers during the loading/unloading process. The rubber of these bumpers is excellent for absorbing an impact, but is not ideal for the high friction and abrasion created during the loading and unloading process. During loading and unloading, forklifts are occasionally used to move pallets of goods on and off of the trailers. During this process, conventional bumpers are usually shred and destroyed within a few months of heavy use. Conventional bumpers are readily destroyed because the payload weighs the trailer down during loading, causing the rear of the truck to lower closer to the ground, which may bind the bumpers against the loading dock as they are often in communication during the loading or unloading process.

Other bumpers have been fashioned that are composed entirely of UMHW polyethylene, which do protect against shredding—but wouldn't work as you need something that can be compressed and allow the two binding components to rub against each other.

Thus, there is a need for a bumper that is able to endure the abrasion-prone loading and unloading process and endure elemental stresses, as well as absorb the impact from the trailer against the loading dock, configured to be placed between the rear of a truck or trailer and a loading dock.

Patent application No. US4854258A by Hausmann et at filed on Mar. 1, 1985, is for a bumper rub strip assembly, which relates “to a bumper rub strip assembly to protect vessels through a canal lock, related narrow way or a dock. More particularly, this invention relates to a marine bumper rub strip assembly having a ultra-high molecular weight polyethylene rub strip assembled operatively relationship to a mass of rubber.” Hausmann varies from the present invention in that it is preferably designed to be implemented on marine vessels or canal locks, whereas the present on is designed to be employed on the rear bumper of trucks and trailers that commonly dock with loading docks.

Patent application No. EP0868274A1 by Orndoff filed on Nov. 7, 1996, is for a Method of Making a Fender Protective Structure. Orndoff teaches a Fender Protective Structure that is designed to absorb the ‘impact forces, e.g. of ships on dock walls or between holding ships and vessels transported in them.’ Orndoff varies from the present invention in that Orndoff is fashioned to be employed on marine vessels such as ships, as well as on docks; whereas, the present invention is designed to be implemented on the bumper of trucks and trailers that frequently dock with loading docks of warehouses or other stationary buildings.

Patent application No. US 6,209,857 B1 by Berends filed on Jun. 29, 1998 is for a Bumper Device. Berends teaches a bumper device that is designed to be mounted to a stationary object such as loading dock or a stationary dock, Berends Bumper Device is equipped with removable bumper that slides into place making it easy to replace without tools. Unlike the present invention, Berends is fashioned to be mounted to stationary objects such as buildings rather than the bumper of trucks or trailers. Additionally, Berends Bumper device is mounted differently from the present invention.

Patent application No. US6832570B2 is for “Fender with compact spring element,” published on Dec. 21, 2004 by Karl L. Aschenbach. Aschenbach teaches a compressible fender which employs a spring element for compression. Aschenbach differs from the present invention in that the present invention employs rubber to provide the compressive element of the bumper, whereas Aschenbach utilizes a spring element which is more prone to wear out,

Additionally, U.S. Pat. No. 6,209,857B1, filed on Jun. 29, 1998 by Berends is for a Bumper Device, as mentioned above, citing a “bumper device mounted on a stationary object (12) to absorb a shock in the case a vehicle collides against the object incorporates at least one body (3) of resilient material, and at least on the front part of the body a closed and flat front element (2) with a low coefficient of friction,” While Berends is similar to the present invention in that it has an exterior layer with a low coefficient of friction such as UMHW polyethylene, Berends varies from the present invention in that the flat front element is positioned and shaped differently, and does not prove as durable under variable conditions.

### SUMMARY OF THE PRESENT INVENTION

The present invention is a ruggedized bumper configured to be affixed to the rear of trailers and trucks designed to be docked with loading docks. It is preferably composed of two layers, a first layer composed of a conventional high density rubbery polymer or gum rubber, and a second layer, thicker than the first layer, composed of UHMW (Ultra-High Molecular Weight) Polyethylene. UHMW Polyethylene is the ideal material to be employed by the present invention to achieve maximum durability. UHMW is highly resistant to abrasion, in some cases up to 15 times as abrasion resistant as carbon steel.

The multiple layer system is critical to the present invention. The first layer, preferably composed of rubber, is configured to absorb the initial impact via compression when the trailer initially binds with the loading dock during the initial docking process, namely when the rear bumper of the truck comes into contact with the loading dock. The second layer is composed of a UHMW polyethylene polymer, configured to be in communication with the first layer, preferably located in a position between the rear of the truck or trailer and the second layer. The second layer is more durable than the first layer as it is the second layer that comes into direct contact with the loading dock.

It should be noted that while the UHMW polyethylene second layer is critical to the durability of the present invention, it would be disadvantageous to construct a bumper completely out of this durable material, as it is non-compressive, and would not fare well in a direct impact, potentially causing damage to the rear of the truck or trailer upon impact. The molecular structure of the UMHW polyethylene prohibits easy compression. The ratio of rubber (first layer) to UHMW polyethylene second layer) is preferably proportionally consistent across all sizes of the present invention, in order to ensure compression is facilitated when the present invention is struck against a loading dock.

While the UMHW polyethylene is critical to the function of the present invention, it would be inadvisable to construct the entire bumper out of the UMHW polyethylene, as UMHW polyethylene is not easily compressed due to the molecular structure of UMHW polyethylene.

The second layer, composed of UMHW polyethylene, is designed to endure the elements from weather, such as erosion from rain or wind, or decay from moisture. The UMHW polyethylene is UV resistant, capable of enduring the heat and UV radiation from the sun.

When the layers are combined during installation, they form a unitary body, bound together by mounting bolts, which is effective at protecting the bumper of a vehicle from damage during the process of loading, unloading, and docking at a loading dock of a building. The layers of the present invention are configured to provide protection to the rear of the truck or trailer for a long period of time.

### BRIEF DESCRIPTION OF THE DRAWINGS

FIG. 1 displays the two layers of the present invention from the side.

FIG. 2 depicts the present invention in the preferred position on the end of a truck or trailer.

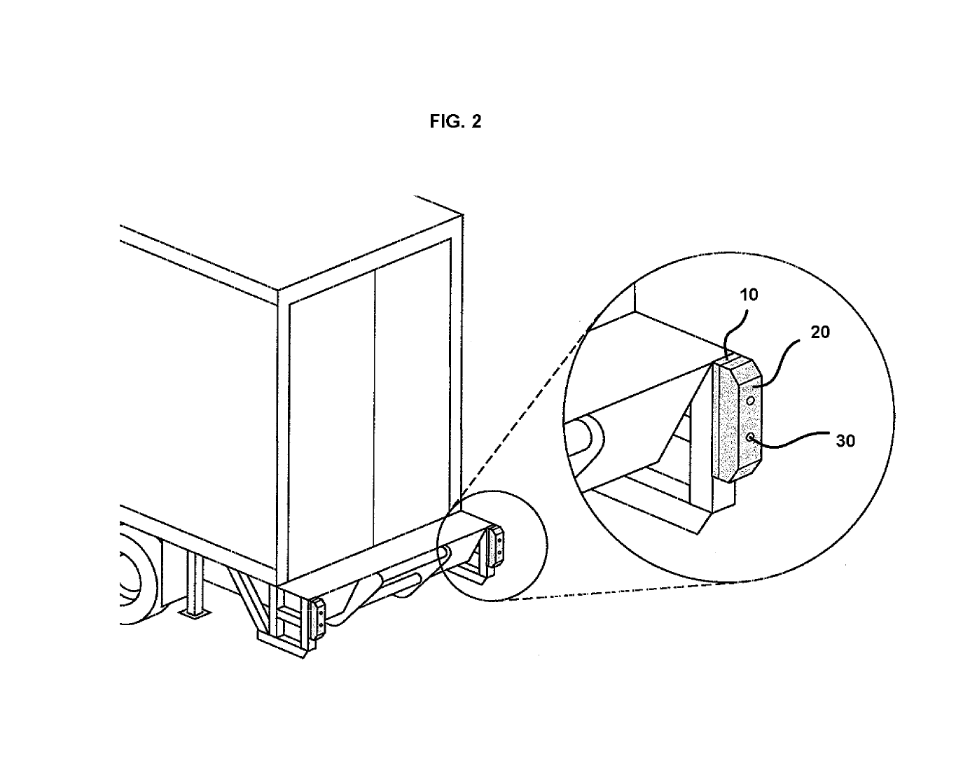

FIG. 3 shows the present invention from the front, exhibiting the abrasion resistant UHMW polyethylene material.

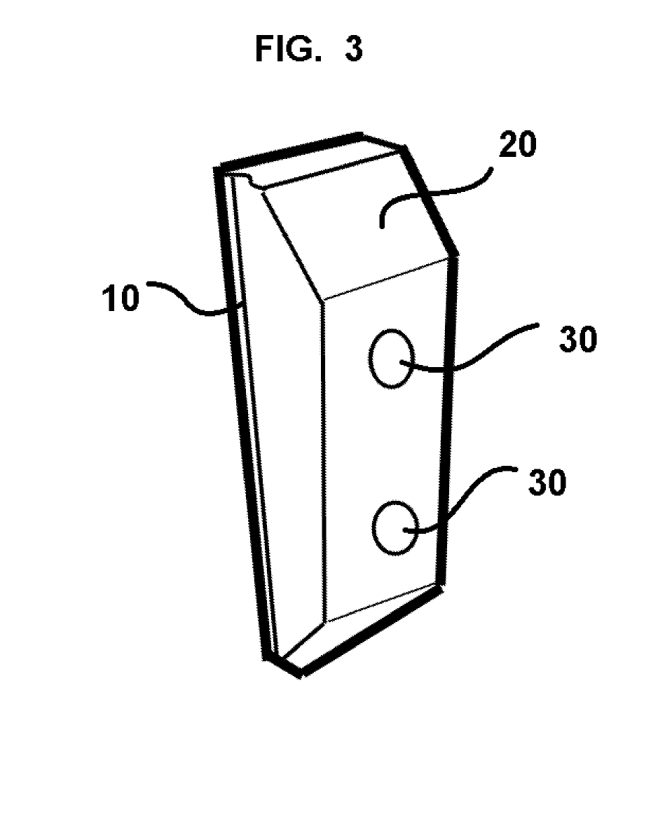

### DETAILED DESCRIPTION OF THE PREFERRED EMBODIMENT

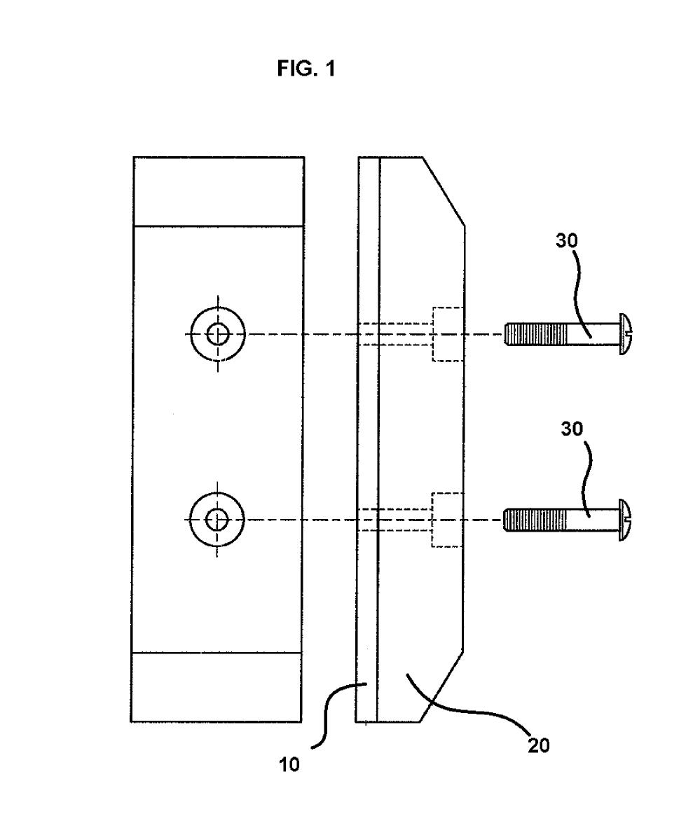

The present invention is a bumper, configured to be highly durable and fashioned out of an anti-abrasive material such as UHMW Polyethylene. The present invention preferably has two layers as seen in FIG. 1, a first layer (10) and a second layer (20). The first layer (10) is preferably composed of a conventional rubber that is used to absorb the energy from an impact as the rubber is compressed. The conventional rubber is ideal for absorbing the energy from a collision between the truck or trailer rear end and the loading dock.

The first layer (10) of the present invention is preferably composed of a form of rubber or a rubber polymer similar to that of conventional ‘gum’ rubber, however it is similarly envisioned that the first layer (10) of the present invention could be composed of similar polymers or products with a similar molecular structure to that of gum rubber. The dual layer structure of the present invention is critical to maintaining its durability over a long period of time.

The second layer (20) of the present invention is preferably placed as the exterior layer of the present invention, as seen in FIG. 1. Therefore, when the present invention is mounted to the rear of a truck or trailer, the mounting bolts are placed through the mounting holes (40) on the second layer (20) and are held in place via a mounting plate on the rear of the truck or trailer. The mounting bolts may be secured via a conventional nut, or the mounting bolts may simply screw into threaded holes drilled into the bumper of the truck or trailer rear.

The first layer (10) and the second layer (20) of the present invention are configured with at least two mounting holes (40) aligned together such that when the second layer (20) is placed on top of the first layer (10) during assembly, the mounting holes (40) line up. The mounting holes (40) are preferably placed on the center vertical axis of the first layer (10) and the second layer (20).

The mounting holes (40) are designed to receive at least two bolts or screws, which are employed to mount the present invention to the rear of a truck or trailer. It is envisioned that conventional steel bolts are employed to mount the present invention, however the bolts could be composed of any durable, corrosion and weather resistant material, preferably a metal or strong acrylic/plastic polymer. In the preferred embodiment of the present invention, it is envisioned that the bolts are to be easily accessible for removal of the present invention in the event that the first layer (10) of rubber or the second layer (20) of UHMW polyethylene become worn, and the present invention must be replaced. Depending on the size or scale of the present invention, the bolts and corresponding mounting holes (40) are preferably available in an assortment of sizes and variations in order to accommodate a ranging size of truck and trailer bumpers/rears.

It should be understood that, in alternate embodiments of the present invention, the second layer (20), preferably composed of UHMW Polyethylene, may be fashioned of a number of different colors or designs. Ideally, the second layer (20) of the present invention is much thicker than the first layer (10), and is shaped similar to a trapezoid, conventional for dock and trailer bumpers, as seen in FIG. 4. However, it can be envisioned that the present invention may function equally well when shaped as any of a number of other shapes, including but not limited to the following shapes: square, rhombus, diamond, rectangle, etc. The present invention may be molded in any of these shapes for cosmetic reasons according to the requirements of the buyer. The buyer may preferably specify the specific specifications of the present invention, including color, shape, size, density, and length. The size of the present invention is preferably crafted to be proportional to the truck or trailer bumper it is to be installed on.

In the primary embodiment of the present invention, the first layer (10) and the second layer (20) are preferably bound together during the manufacturing process. However, in an alternate embodiment of the present invention, the first layer (10) and the second layer (20) are preferably kept separate until assembly and installation on the rear of a truck or trailer.

It is envisioned that the preferred embodiment of the present invention would preferably be molded or fashioned out of a single color of UHMW polyethylene, however, it is possible that multiple colors or patterns may be employed on the present invention in order to make the bumper more noticeable to drivers, in order to prevent impacts from other vehicles or during loading and unloading.

Finally, it should be understood that the present invention is not solely limited to the invention as described in the embodiments above, but further comprises any and all embodiments within the scope of this application.

I claim:

1. A bumper for a trailer comprising:
a first layer;
a second layer;
wherein said first layer is composed of rubber;
wherein second layer is composed of Ultra-High-Molecular-Weight Polyurethane;
wherein said second layer is thicker than said first layer;
wherein said first layer is in communication with said second layer; and
wherein said first layer is in communication with the trailer.

2. The bumper for a trailer of claim 1, further comprising:
a bolt securing said second layer to said first layer and the trailer.

3. The bumper for a trailer of claim 1, wherein said rubber is vulcanized.

4. A bumper for a junction point of a loading dock and container comprising:
a first layer;
a second layer;
wherein said first layer is composed of rubber;
wherein second layer is composed of Ultra-High-Molecular-Weight Polyurethane;
a bolt;
a nut;
wherein said first layer is affixed to said second layer via said bolt and said nut; and
wherein said second layer faces outward, towards the junction point.

5. The bumper for a junction point of a loading dock and container, wherein said second layer is a trapezoid.

6. The bumper for a junction point of a loading dock and container of claim 4, wherein said second layer is thicker than said first layer.

7. The bumper for a junction point of a loading dock and container of claim 4, wherein said second layer is replaceable.

8. A bumper for docking comprising:
a first layer;
a second layer;
wherein said first layer is composed of rubber;
wherein second layer is composed of Ultra-High-Molecular-Weight Polyurethane;
wherein said second layer is thicker than said first layer;
wherein said first layer is in communication with said second layer;
wherein said first layer is in communication with a mounting point;
wherein said second layer is a trapezoid;
a bolt;
a nut;
wherein said first layer is affixed to said second layer via said bolt and said nut; and
wherein said second layer faces opposite of said mounting point.
